(19) United States
(12) Patent Application Publication
(10) Pub. No.: US 2025/0016111 A1
(43) Pub. Date: Jan. 9, 2025

(54) TRANSMISSION DEVICE, METHOD, AND STORAGE MEDIUM

(71) Applicant: DENSO CORPORATION, Kariya-city (JP)

(72) Inventor: Tsuneo NAKATA, Kariya-city (JP)

(21) Appl. No.: 18/890,598

(22) Filed: Sep. 19, 2024

Related U.S. Application Data
(63) Continuation of application No. PCT/JP2022/047782, filed on Dec. 23, 2022.

(30) Foreign Application Priority Data
Mar. 22, 2022 (JP) 2022-045816

(51) Int. Cl. H04L 47/62; H04L 47/125; H04L 47/283

(52) U.S. Cl. CPC H04L 47/624; H04L 47/125; H04L 47/283

(57) ABSTRACT

A transmission device transmits packets through communication paths with load distribution. The device includes a calculation unit that, based on data amounts of packets held in order of arrival and line speeds of the paths, calculates predicted delays, which are time periods required for arrival of the packets at a reception device when the packets are transmitted through the paths; a selection unit that, when selecting the paths that transmit the packets so that the packets are received by the reception device in the order of arrival, as a packet to be transmitted through a high-latency communication path having the largest predicted delay when packets having the same data amount are transmitted, selects a packet that is later in the order of arrival than a packet selected based on the predicted delay; and a transmission unit that transmits the packets through the respective selected paths.

### CROSS-REFERENCE TO RELATED APPLICATION

The present application is based on and claims the benefit of priority from earlier Japanese Patent Application No. 2022-045816 filed on Mar. 22, 2022, the description of which is incorporated herein by reference.

### BACKGROUND

### Technical Field

The present disclosure relates to a transmission device, a transmission method, and a storage medium.

### Related Art

Conventionally, techniques are known which distribute a communication load between communication paths to provide communication paths having a large capacity which is difficult to implement by a single path.

### SUMMARY

An aspect of the present disclosure is a transmission device that transmits a plurality of packets through a plurality of communication paths with load distribution, the device including: a calculation unit that, based on data amounts of packets held in a holding unit, which holds the plurality of packets arriving from a higher layer in order of arrival, and line speeds of the plurality of communication paths, calculates predicted delays, which are time periods required for arrival of the packets at a reception device when the packets are transmitted through the plurality of communication paths; a selection unit that, when selecting the communication paths that transmit the plurality of packets so that the plurality of packets are received by the reception device in the order of arrival, as a packet to be transmitted through a high-latency communication path having the largest predicted delay when packets having the same data amount are transmitted, selects a packet that is later in the order of arrival than another packet that is selected based on the predicted delay; and a transmission unit that transmits the plurality of packets through the respective communication paths selected by the selection unit.

### BRIEF DESCRIPTION OF THE DRAWINGS

In the accompanying drawings:

FIG. 1 is a block diagram illustrating a schematic configuration of a communication system;

FIG. 2 is a block diagram illustrating a hardware configuration of a transmission device;

FIG. 3 is a functional block diagram of the transmission device;

FIG. 4 is a diagram for describing conventional transmission when a communication path speeds up;

FIG. 5 is a diagram for describing transmission according an embodiment when a communication path speeds up;

FIG. 6 is a diagram for describing an example of a method of setting a numerical value of a margin;

FIG. 7 is a diagram for describing an example of the method of setting a numerical value of a margin when the margin is defined as an amount;

FIG. 8 is a diagram for describing an example of the method of setting a numerical value of a margin when three or more communication paths are present;

FIG. 9 is a sequence diagram illustrating an example of transmission timings; and

FIG. 10 is a flowchart of an example of a transmission process.

### DETAILED DESCRIPTION OF THE PREFERRED EMBODIMENTS

Conventionally, techniques are known which distribute a communication load between communication paths to provide communication paths having large capacity, which is difficult to implement by a single path.

However, although bandwidth is increased by multiplexing, since transmission speed is limited by a path having the greatest delay among a plurality of paths, delay may increase due to the multiplexing of paths having different delays.

In order to avoid decrease of the effect of load distribution due to increase of a delay difference between paths described above, for example, Japanese Patent No. 4488256 discloses the following technique. According to the technique disclosed in Japanese Patent No. 4488256, scheduled transmission paths of packets to be transmitted are determined based on estimated values of latencies and throughputs of the paths so that a sequence of predicted arrival times at a reception node is equal to a sequence of arrival times at transmission node. Then, a path 1 having an allowed delay that is a maximum among the paths transmits a packet which is not the head, from among transmission waiting packets. Hence, appropriate loads can be imposed on the paths while reducing the delay difference between the paths, whereby communication efficiency is optimized.

According to the above technique, the time period required for arrival of a final packet transmitted through the path 1 lengthens as an allowable delay of the path 1 is longer. Hence, the communication states of paths other than the path 1 are highly likely to change during the time period. Thus, there is a problem that when the line speeds of the paths other than the path 1 further increase, transfer delays of packets may occur downstream from the reception node due to resolution waiting time for a packet arrival sequence to the reception node.

In view of the above points, the present disclosure has an object of suppressing a transfer delay on the reception side even when a path in which a delay is short speeds up more than expected when packets are transmitted through a plurality of communication paths with load distribution.

Hereinafter, an embodiment of the present disclosure will be described with reference to the drawings.

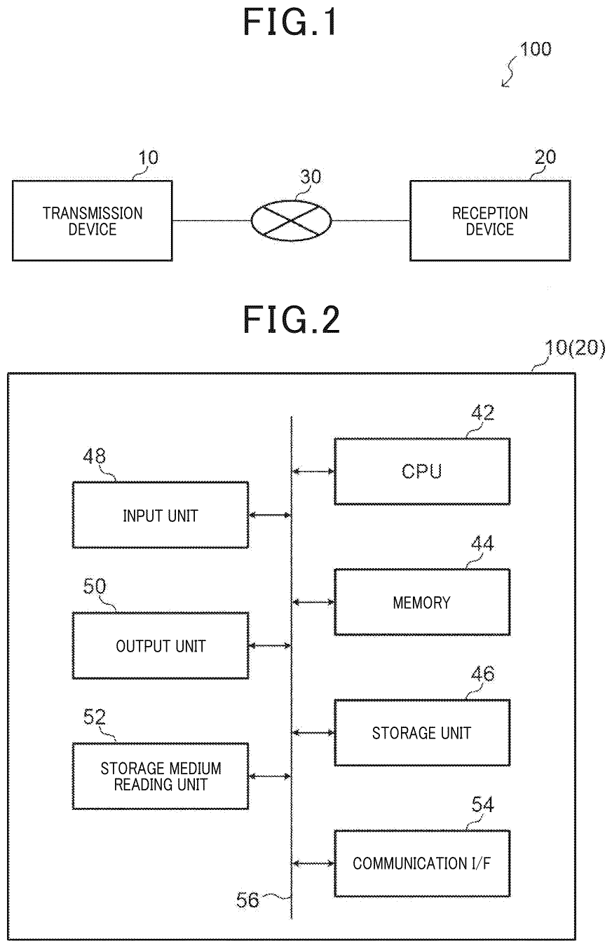

As illustrated in FIG. 1, a communication system 100 according to the present embodiment includes a transmission device 10 and a reception device 20. The transmission device 10 and the reception device 20 are connected via a communication line 30 and transmit data to each other and receive data from each other. The communication line 30 is configured by multiplexing a plurality of communication paths. It is noted that the number of each of the transmission devices 10 and the reception devices 20 included in the communication system 100 is not limited to that of the example in FIG. 1 but may be two or more.

FIG. 2 illustrates a hardware configuration of the transmission device 10. As illustrated in FIG. 2, the transmission device 10 has a CPU (Central Processing Unit) 42, a memory 44, a storage unit 46, an input unit 48, an output unit 50, a storage medium reading unit 52, and a communication I/F (Interface) 54. The components are connected so as to be capable of communicating with each other via a bus 56.

The storage unit (storage medium) 46 stores a transmission program for implementing the transmission process described later. The CPU (computer) 42 is a central processing unit that performs various programs and controls each of the components. That is, the CPU 42 reads the program from the storage unit 46 and executes the program using the memory 44 as a working area. The CPU 42 performs control of each of the components and various types of arithmetic processing according to the program stored in the storage unit 46.

The memory 44 is configured by a RAM (Random Access Memory) and functions as a working area to temporarily store programs and data. Part of the memory 44 functions as a transmission queue (holding unit). The storage unit 46 is configured by a ROM (Read Only Memory), an HDD (Hard Disk Drive), an SSD (Solid State Drive), and the like and stores various programs including an operating system and various types of data.

The input unit 48 is a unit for performing various types of input, such as a keyboard and a mouse. The output unit 50 is a unit for outputting various types of information, such a display and a printer. A touch panel display may be employed as the output unit 50 to function as the input unit 48.

The storage medium reading unit 52 performs reading of data stored in various storage mediums such as a CD (Compact Disc) ROM, a DVD (Digital Versatile Disc) ROM, a Blu-ray disc, and a USB (Universal Serial Bus) memory, writing data to the storage medium, and the like. The communication I/F 54 is an interface for communicating with other devices including the reception device 20. For example, standards such as Ethernet (registered trademark), FDDI, and Wi-Fi (registered trademark) may be used.

Since the hardware configuration of the reception device 20 is substantially similar to the hardware configuration of the transmission device 10 illustrated in FIG. 2, redundant descriptions are omitted. It is noted that the storage unit 46 of the reception device 20 stores a reception program for implementing each type of processing of the reception device 20.

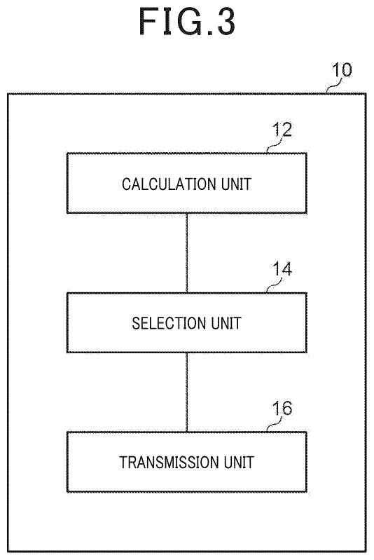

Next, with reference to FIG. 3, a functional configuration of the transmission device 10 according to the present embodiment will be described. As illustrated in FIG. 3, the transmission device 10 includes a calculation unit 12, a selection unit 14, and a transmission unit 16. Each of the functional units is implemented by the CPU 42 illustrated in FIG. 2.

First, a transmission queue of the transmission device 10 stores, for each packet, transmission waiting data arriving from a higher layer of a network layer. The plurality of packets are held in the transmission waiting data in order of arrival. Sequence numbers (hereinafter, seq) are added to the packets held in the transmission queue in the order of arrival. It is noted that the transmission queue is an example of the holding unit of the present disclosure. Part of the memory 44 of the transmission device 10 functions as the transmission queue.

The calculation unit 12 calculates a predicted delay, which is a time period between transmission of a packet held in the transmission queue from the transmission device 10 and arrival of the packet at the reception device 20. The calculation unit 12 calculates the predicted delay based on data amounts of the packets held in the transmission queue and line speeds of the plurality of communication paths.

The selection unit 14 selects one communication path for transmitting each of a plurality of packets from among the plurality of communication paths so that the plurality of packets held in the transmission queue are received by the reception device 20 in the order of arrival at the transmission queue. In this case, if a communication path having the largest value of the predicted delay calculated by the calculation unit 12 (hereinafter, referred to as a high-latency communication path) is selected, the selection unit 14 selects a packet that is later in the order of arrival at the transmission queue than another packet that is selected to be transmitted based on the predicted delay calculated by the calculation unit.

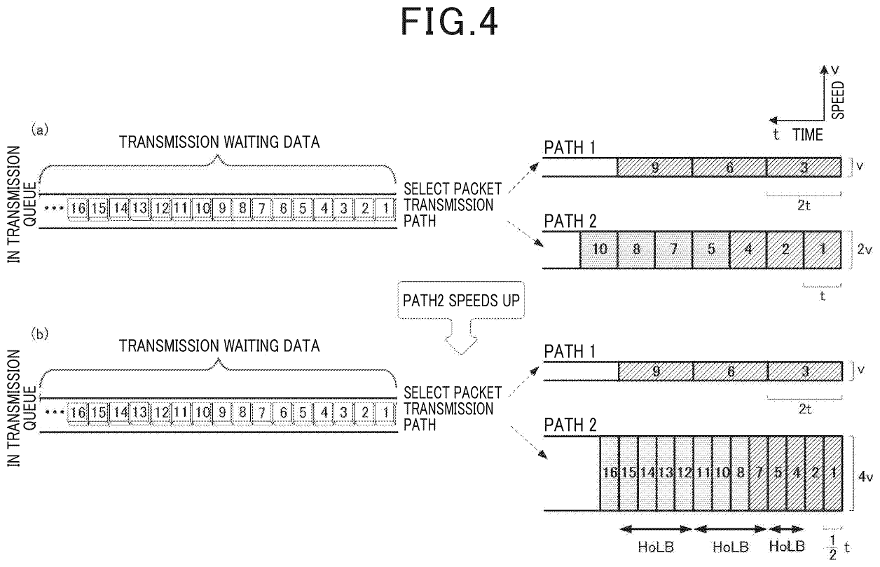

With reference to FIG. 4, methods of selecting packets according to the present embodiment and a comparative example will be described. The comparative example is a method of selecting communication paths that transmit packets based on only predicted delays so that the packets arrive at a reception device in order of sequence numbers.

FIG. 4 illustrates an example in which sequence numbers of packets to be transmitted through a plurality of paths are selected based on the predicted delays. In FIG. 4, t indicates time, and v indicates a line speed of the communication path. In FIG. 4, time t increases leftward, and line speed v increases upward. In addition, the left side is the transmitting side, and the right side is the receiving side. Cubic blocks indicate packets that have arrived at the transmission queue and remain side by side in order of the sequence numbers. Planar blocks indicate selected packets after being assigned to the plurality of paths. In addition, the width of the planar block indicates a time period required for transmitting a packet corresponding to the block. The height of the block indicates a speed at which the packet corresponding to the block is transmitted. In the plurality of planar blocks, packets closer to the receiving side arrive earlier. In addition, a path 1 in FIG. 4 indicates a high-latency communication path. In contrast, a path 2 indicates a communication path that is not a high-latency communication path (hereinafter, referred to as a low-latency communication path).

Referring to FIG. 4, selection of a communication path that transmits packets and the transmission according to the comparative example will be described in detail.

First, packets are stored in the transmission queue in order of sequence numbers. Next, a path that transmits packets is selected from among a plurality of paths. More specifically, as illustrated in FIG. 4(a), when the line speed of the path 1, which is a high-latency communication path, is v, and the line speed of the path 2, which is a low-latency communication path, is 2v, if the data amounts of the packets are the same, the predicted delay of one packet in the path 1 is 2t, and the predicted delay of one packet in the path 2 is t. Based on the predicted delay of each of the paths, for example, packets of [seq1, seq2] are selected so as to be transmitted through the path 2, and a packet of [seq3] is selected so as to be transmitted through the path 1. Subsequently, packets of [seq4, seq5] are selected so as to be transmitted through the path 2, and a packet of [seq6] is selected so as to be transmitted through the path 1. Hence, the packets are transmitted so that transmission and reception of the packet of [seq3] through the path 1 is completed at the timing at which transmission and reception of the packets of [seq1, seq2] through the path 2 are completed. Next, the packets are transmitted so that transmission and reception of the packet of [seq6] through the path 1 is completed at the timing at which transmission and reception of the packets of [seq4, seq5] through the path 2 are completed.

As described above, according to the comparative example, paths through which packets are transmitted are selected based on the calculated predicted delays so that dead waiting time is suppressed, that is, the packets arrive at the reception device in order of sequence numbers.

However, as illustrated in FIG. 4(b), when packets are actually transmitted, the line speed of the path 2 may become higher than that at the time at which the predicted delay is calculated. FIG. 4(b) illustrates an example in which the line speed of the path 2 increases from 2v to 4v. That is, in the path 2, the delay of one packet is ½t. In this case, if packets selected by a method similar to that of FIG. 4(a) are transmitted in order of the sequence numbers, the packet having a sequence number larger than that of the packet that has not arrived on the path 1 arrives earlier on the path 2. Hence, when packets are transferred downstream of the reception device in order of sequence numbers, the packet that has arrived earlier on the path 2 is required to wait for arrival of a packet having a sequence number smaller than that thereof. This is referred to as Head Of Line blocking (hereinafter, HoLB). As a result of the occurrence of HoLB, in the reception device, a transfer delay occurs downstream from the reception device due to sequence resolution waiting time.

In the example in FIG. 4(b), until transmission of the packet of [seq3] is completed on the path 1, the packets of [seq1, seq2, seq4, seq5] can be transmitted through the path 2. However, until the transmission of the packet of [seq3] is completed on the path 1, the packets of [seq4, seq5] transmitted through the path 2 have to wait to be transferred. That is, HoLB has occurred in the packets of [seq4, seq5]. Similarly, HoLB has occurred in the packets of [seq7] and later in the path 2. As described above, the comparative example has a problem that a transfer delay occurs downstream when the line speed of the path 2 is high, because of frequent occurrence of HoLB or increase of waiting time due to HoLB. That is, if only the order of arrival based on the predicted delay is considered, a transfer delay occurs when a low-latency communication path speeds up.

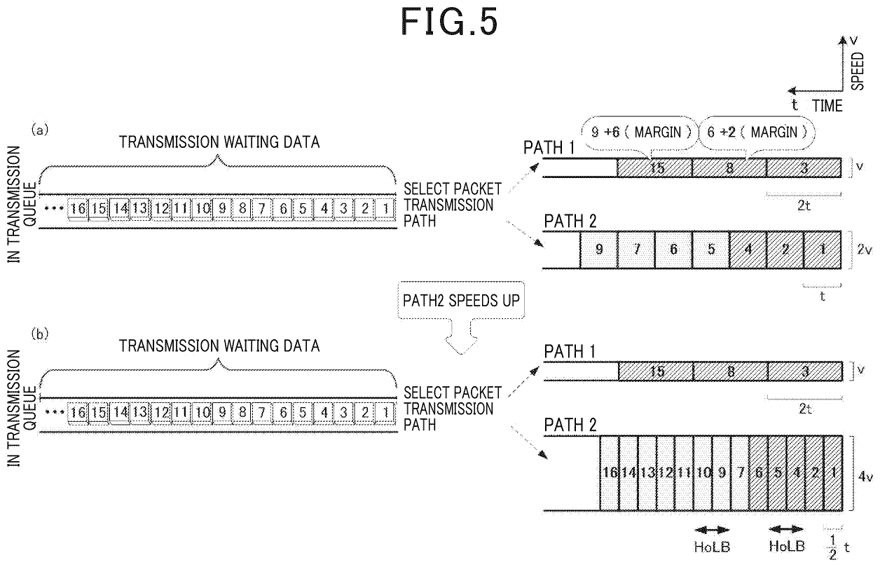

Thus, if a high-latency communication path is selected, the selection unit 14 of the present embodiment selects a packet that is later in the order of arrival than another packet that is selected to be transmitted based on the predicted delay calculated by the calculation unit 12. Specifically, as illustrated in FIG. 5, on the path 1 that is a high-latency communication path, the selection unit 14 selects a packet having a sequence number that is obtained by providing a margin to the sequence number of the packet selected based on the predicted delay calculated by the calculation unit 12.

For example, in an example similar to that of FIG. 4(a), as illustrated in FIG. 5(a), the selection unit 14 provides a margin of +2 to the packet of [seq6] selected as a packet transmitted through the path 1 based on the predicted delay. Hence, in a case in which the packet of [seq6] is selected based on the predicted delay, the selection unit 14 selects the packet of [seq8] as a packet to be transmitted through the path 1. Similarly, in FIG. 5(a), the selection unit 14 provides a margin of +6 to the packet of [seq9] selected based on the predicted delay and selects the packet of [seq15] as a packet to be transmitted through the path 1.

As described above, the selection unit 14 selects a packet having a sequence number that has been provided with a margin so as to be transmitted through a high-latency communication path. According to the selection method, even when the path 2 has sped up, as illustrated in FIG. 5(b), although HoLB occurs at first, influence on subsequent packets on the path 2 decreases. As a result, compared with the case of FIG. 4(b) that is a comparative example, a transfer delay downstream due to HoLB decreases.

Next, a method of setting a margin performed by the selection unit 14 will be described.

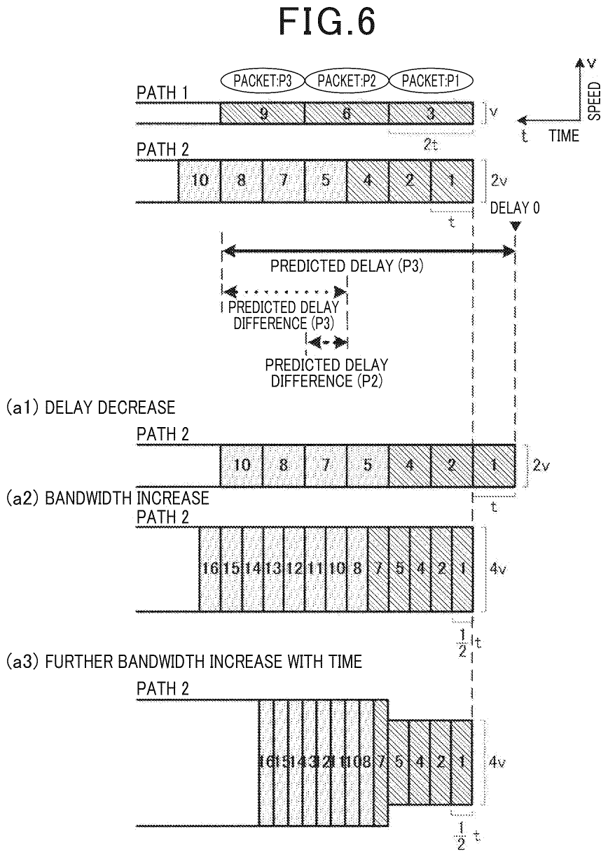

With reference to FIG. 6, a specific example of a margin in a case of being defined by a natural number will be described. In FIG. 6, packets to be transmitted through the path 1 are indicated by P1, P2, and P3 in order of transmission.

First, as variables used for setting a margin, for example, the following three types of variables are defined.

As a first type variable, a predicted delay difference i will be described. The predicted delay difference i is a time period obtained as a difference between a predicted delay t₁ of each packet to be transmitted through a high-latency communication path and a predicted delay t₂ of a final packet to be transmitted through a low-latency communication path within a range of packets that can be transmitted within an allowable delay described later. In FIG. 6, hatched blocks indicate packets transmitted within the allowable delays of the communication paths, and dotted blocks indicate packets transmitted after the transmission of the packets of the hatched blocks. This is similar in FIG. 4, FIG. 5, and FIG. 8. The timing of the transmission will be described later.

The example in FIG. 6 illustrates a case in which the number of packets that can be transmitted within an allowable delay is three in each of the path 1 and the path 2. In addition, the predicted delay of each packet corresponds to an elapsed time period from the time of delay 0, which is the time at which a packet is transmitted from the transmission device 10, to arrival of the packet at the reception device 20. For example, a predicted delay (P3) regarding packet P3 corresponds to the width of a solid two direction arrow in FIG. 6. In this case, as indicated by a dotted two direction arrow in FIG. 6, the predicted delay difference (P3) regarding packet P3 is a time period obtained by subtracting a predicted delay of three packets on the path 2 from the predicted delay (P3) of packet P3 on the path1. Similarly, a predicted delay difference (P2) regarding packet P2 also corresponds to the width of a dashed two direction arrow in FIG. 6. The predicted delay difference i is expressed by the following expression (1).

$$i [ Predicted delay difference ] = {t}_{1} [ Predicted delay of path 1 ] - {t}_{2} [ Predicted delay of path 2 ] \qquad ( 1 )$$

As a second type variable, an offset j will be described. The offset j is the data amount obtained by multiplying the predicted delay difference i by a line speed v₂ of the low-latency communication path. The offset j is expressed by the following expression (2).

$$j [ Offset ] = i [ Predicted delay difference ] * {v}_{2} [ Line speed of path 2 ] \qquad ( 2 )$$

As a third type variable, an unloaded time offset k will be described. The unloaded time offset k is the data amount obtained by multiplying the predicted delay t₁ of the high-latency communication path by the line speed v₂ of the low-latency communication path. The unloaded time offset k is expressed by the following expression (3).

$$k [ Unloaded time offset ] = {t}_{1} [ Predicted delay of path 1 ] * {v}_{2} [ Line speed of path 2 ] \qquad ( 3 )$$

Next, calculation of a margin using the above variables i, j, k will be described. Hereinafter, five calculation methods expressed by the following expressions (4) to (8) are exemplified

It is noted that, in the expressions (4) to (8), the selection unit 14 determines the variables i, j, k by the above expressions (1) to (3) and sets a constant a to an arbitrary value. The selection unit 14 may set the constant a to different values in the expressions. The selection unit 14 may dynamically set the constant a depending on the number of packets held in a transmission queue so that the sequence number to which a margin is added does not exceed the maximum value of the sequence numbers of the packets held in the transmission queue.

$${m}_{1} = {v}_{2} [ Line speed of path 2 ] * a \qquad ( 4 )$$

$${m}_{2} = k [ Unloaded time offset k ] * a \qquad ( 5 )$$

$${m}_{3} = j [ Offset ] * a \qquad ( 6 )$$

$${m}_{4} = {t}_{1} [ Predicted delay of path 1 ] * {m}_{2} \qquad ( 7 )$$

$${m}_{5} = i [ Predicted delay difference ] * {m}_{2} \qquad ( 8 )$$

If the predicted delay difference i is a constant value or larger, the selection unit 14 may calculate a value of a margin m by using any of the expressions (4) to (8). If the predicted delay difference i is smaller than the constant value, the selection unit 14 may set the margin m=0. If disruption to a packet arrival sequence in the reception device 20 is negligibly small, reduction of a processing load and efficiency optimization are prioritized. The selection unit 14 converts the value of the margin m calculated by using any of the expressions (4) to (8) to the number of packets, thereby defining the margin, which is a natural number.

In addition, the following are effects obtained when the margins calculated by using the expressions (4) to (8) are applied.

Expression (4): Influence exerted when the delay of the path 2 decreases (For example, as illustrated in FIG. 6(a1), the delay from the time at which the delay is 0 to the arrival of the first packet) is reduced.

Expression (5): Influence exerted when the bandwidth of the path 2 increases (the line speed of the path 2 is higher than that at the time when the predicted delay is calculated) is reduced.

Expression (6): Influence exerted when the bandwidth of the path 2 increases after the final packet is received is reduced.

Expression (7): Influence exerted when the bandwidth of the path 2 increases with time (FIG. 6(a3)) is reduced.

Expression (8): Influence exerted when the bandwidth of the path 2 further increases with time after the final packet is received is reduced.

In the example in FIG. 5, margins of the above expression (6) are added to sequence numbers of packets to be transmitted secondarily and thirdly through the path 1. Specifically, a margin is set to a value that is twice the number of packets that are scheduled to arrive through the path 2 between each of the predicted delays of the packets and the predicted delay of the final packet of [seq4] to be transmitted through the path 2. This corresponds to setting that prevents HoL blocking until the path 2 doubles in speed after the packet of [seq4] is received.

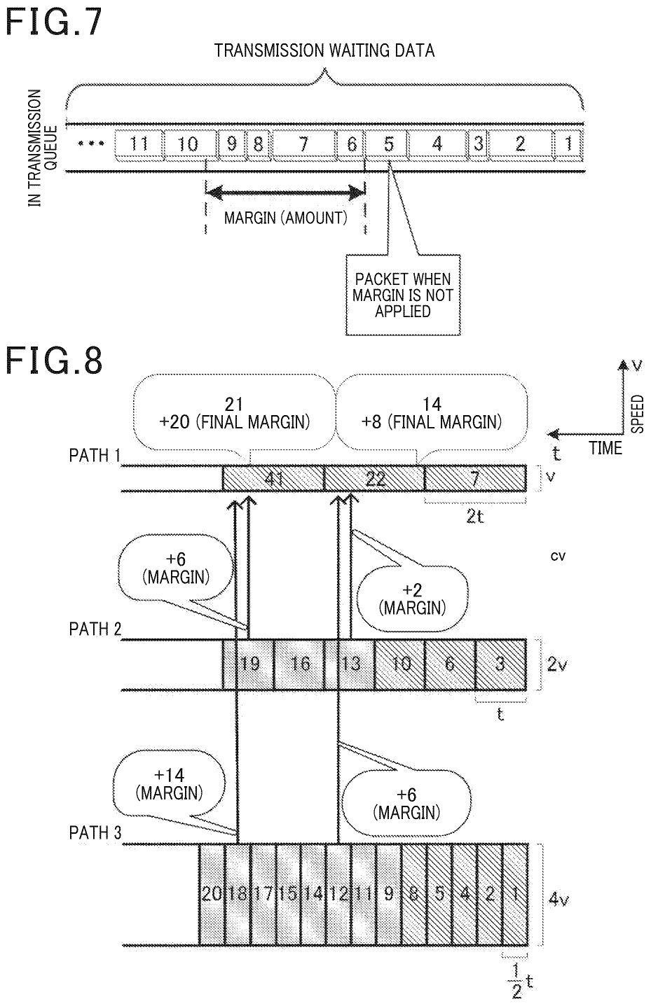

Next, a case in which a margin is defined by the data amount will be described. Although the value of the margin can be calculated by using any of the five calculation expressions described above, the margin may not be defined by a natural number by converting the calculated value to the number of packets. For example, as illustrated in FIG. 7, the data amounts of the packets may not be the same. Hence, the selection unit 14 defines the margin by the data amount and selects a packet having a sequence number based on the margin by using the following method.

Specifically, the selection unit 14 obtains, based on the predicted delays, the sum of the data amounts of sequential packets, which are from the packet next to the packet, to which no margin is applied, selected so as to be transmitted through the high-latency path to a predetermined packet. In the example of FIG. 7, the packet to which no margin is applied is [seq5], and the next packet is [seq6]. Next, the selection unit 14 selects, as a packet to be transmitted through the high-latency path, the predetermined packet by which the difference between the data amount defined as the margin obtained by using any of the above five calculation expressions and the sum described above is within a predetermined range.

The selection unit 14 selects the predetermined packet by which the above difference is within the predetermined range according to any of the following three patterns.

1. The maximum sequence number meeting a margin (data amount)>the sum of the data amounts of the packets is selected.

2. The minimum sequence number meeting a margin (data amount)≤ the sum of the data amounts of the packets is selected.

3. The sequence number at which the sum of the data amounts of the packets is closest to a margin (data amount).

For example, in the case of FIG. 7, the selection unit 14 selects [seq9] in pattern 1, [seq10] in pattern 2, and [seq9] in pattern 3.

Next, a method of setting a margin when two or more low-latency communication paths are present will be described.

If two or more low-latency communication paths are present, the selection unit 14 sums margins regarding each low-latency communication path and sets the value as the final margin.

As illustrated in FIG. 8, for example, it is assumed that, before margins are applied, as packets to be transmitted through the path 1, the first packet [seq7], the second packet [seq14], and the third packet [seq21] have been selected. Then, it is assumed that, for the second packet, +2 has been calculated as a margin of the path 2, and +6 has been calculated as a margin of path3. In this case, the sum of margins for the second packet of the path 1 is 2+6, that is, 8. The selection unit 14 selects a packet of [seq 22], 22 being obtained by adding 8 to 14 ([seq 14]), as a packet after the margins are applied.

The transmission unit 16 transmits a plurality of packets held in a transmission queue through respective communication paths selected by the selection unit 14.

It is noted that the transmission unit 16 transmits packets, the number of which is completely transmitted within the set allowable delay. The allowable delay is the maximum value of a delay allowed on each path to balance load distribution between the plurality of communication paths and is set to be longer as the delay of the path is longer.

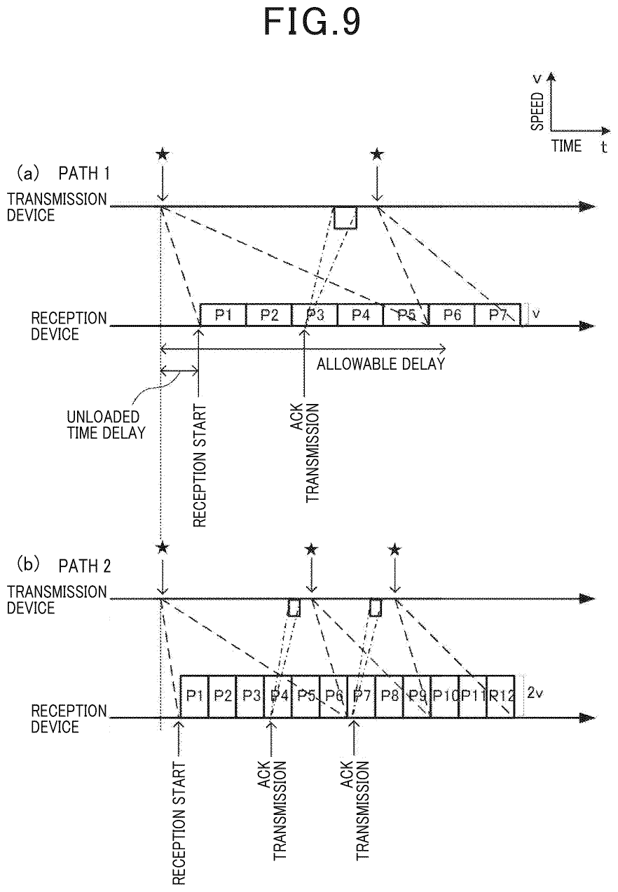

Specifically, when transmission starts, the transmission unit 16 of the transmission device 10 estimates an unloaded time delay indicated in FIG. 9 and a line speed (v in FIG. 9) and sets the maximum data amount which is within the allowable delay as a window size. Then, the transmission unit 16 transmits packets that are selected by taking account of margins and have the window size. The timings at which transmission starts are the same on the path 1 and the path 2. In FIG. 9(a), which illustrates an example of the path 1, as the packets having the window size, packets P1 to P5 are transmitted. It is noted that, based on the sequence number after the selection by the selection unit 14, that is, the sequence number on which a margin is reflected, the packets transmitted first through the paths are indicated by P1, the packets transmitted secondly through the paths are indicated by P2, and so on. The transmission unit 16 receives ACK that is a positive acknowledgement, which is transmitted from the reception device 20 at predetermined timing, of a packet received by the reception device 20. Although the path 1 in FIG. 9(a) illustrates an example in which the reception device 20 transmits ACK to the transmission device 10 every time the reception device 20 receives 2 packets, the timing of transmitting ACK can be appropriately set. On receiving the ACK, in FIG. 9(a), the transmission unit 16 detects normal completion of transmission and reception of P2 and an earlier packet and next transmits two packets (packets P6 to P7) corresponding to a vacancy of the window size.

Similarly, in FIG. 9(b) illustrating an example of the path2, the transmission unit 16 transmits packets at the timing of a transmission start and the timing after ACK is received. FIG. 9(b) illustrates an example in which the window size at the time of the transmission start corresponds to six packets, and the reception device 20 transmits ACK to the transmission device 10 every time when the reception device 20 receives three packets. Hence, at the next and later transmission timings, since there are vacancies corresponding to three packets, the transmission unit 16 transmits three packets at every transmission timing next and later. It is noted that, in FIG. 9, an asterisk indicates the transmission timing of a packet.

At the above transmission timings, the transmission unit 16 may select packets previously selected by the selection unit 14, from the paths or transmit reselected packets at every transmission timing. In the later case, specifically, every time when receiving ACK, the transmission unit 16 provides a notification to the selection unit 14. The selection unit 14 reselects packets to be transmitted through the paths with taking account of margins based on predicted delays or the like at the time when the notification is received. In addition, the transmission unit 16 may determine, at every transmission timing, the amount that can be transmitted at the transmission timing after ACK is received by re-estimating not the vacancy amount of the window but the line speed or the like at the time when ACK is received.

If receiving the packets transmitted from the transmission device 10, the reception device 20 transmits ACK to the transmission device 10 at predetermined timing. In addition, the reception device 20 transfers the packets, which are received through the paths, downstream in order of sequence numbers.

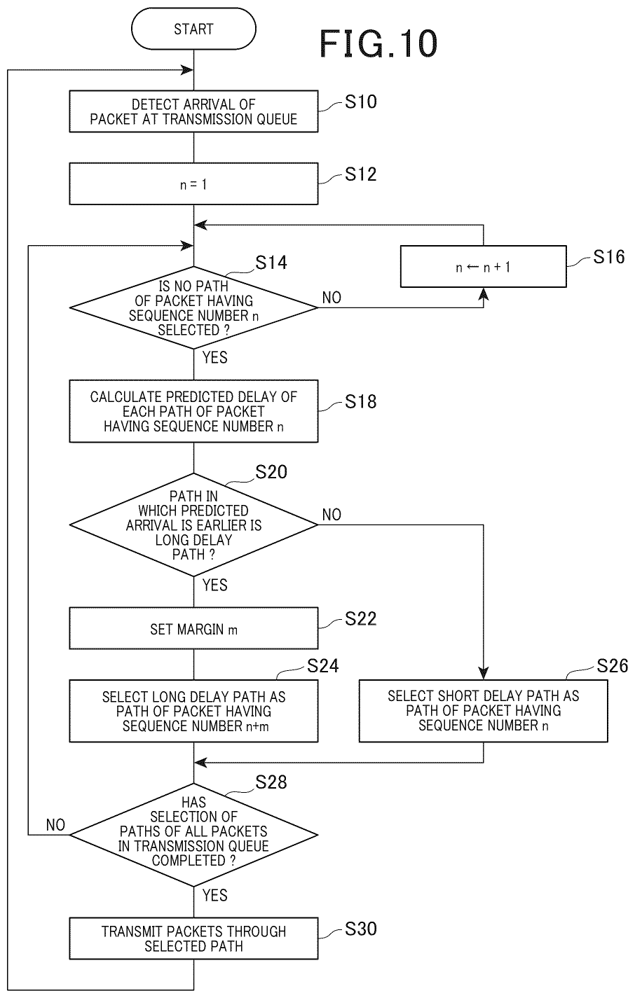

Next, operation of the communication system 100 according to the present embodiment will be described. The transmission device 10 performs a transmission process illustrated in FIG. 10. The transmission process is an example of the transmission method of the present disclosure.

With reference to FIG. 10, the transmission process will be described.

In step S10, if detecting arrival of packets at a transmission queue of the transmission device 10, the calculation unit 12 adds serial sequence numbers sequentially from 1 in order of arrival. Next, in step S12, the calculation unit 12 substitutes 1 in variable n for specifying a sequence number.

Next, in step S14, the calculation unit 12 determines whether no path through which the packet having a sequence number n is to be transmitted has been selected. If the path has been selected (step S14: NO), the process proceeds to step S16, in which the calculation unit 12 increments variable n by 1. Then, the process returns to step S14. If no path has been selected (step S14: YES), the process proceeds to step S18.

In step S18, the calculation unit 12 calculates predicted delays of the respective paths of the packet having a sequence number n. The predicted delay is calculated from the data amount of the transmission waiting data stored in the transmission queue and an estimated line speed of the communication line 30.

Next, in step S20, the selection unit 14 determines whether, among the plurality of paths, the path in which predicted arrival is earlier is a high-latency path, based on the predicted arrival calculated by the calculation unit 12. If the path is not a high-latency path (step S20: NO), the process proceeds to step S26, in which the selection unit 14 selects a low-latency path as a path of the packet having a sequence number n. Then, the process proceeds to step S28. In contrast, if the path is a high-latency path (step S20: YES), the process proceeds to step S22, in which the selection unit 14 sets the margin m. Next, in step S24, the selection unit 14 selects a high-latency path as path of the packet having a sequence number n+m. Then, the process proceeds to step S28.

In step S28, the selection unit 14 determines whether selections of paths of all packets in the transmission queue have been completed. If there is a packet whose path is not selected (step S28: NO), the process returns to step S14. If selections of paths of all packets have been completed (step S28: YES), the process proceeds to step S30, in which the transmission unit 16 transmits the packets through the paths selected by the selection unit 14. Then, the process returns to step S10.

In the above transmission process, after selections of paths of all packets in a transmission queue have been completed, the packets are transmitted. However, the packets may be transmitted after selections of paths of a predetermined number of packets have been completed.

As described above, according to the communication system of the present embodiment, the transmission device, which transmits a plurality of packets through a plurality of communication paths with load distribution, holds the plurality of packets arriving from a higher layer in order of arrival. Then, based on the data amounts of packets held in a transmission queue and line speeds of the plurality of communication paths, predicted delays are calculated which are time periods required for arrival of packets at a reception device when the packets are transmitted through the plurality of communication paths. In addition, the transmission device selects the communication paths that transmit the plurality of packets so that the reception device can receive the plurality of packets in order of arrival at the transmission queue. In this case, as a packet to be transmitted through the high-latency communication path in which the predicted delay is the largest among the plurality of communication paths when the packets having the same data amount are transmitted, the transmission device selects a packet that is later in the order of arrival than the packet that is selected based on the predicted delay. Then, the transmission device transmits the plurality of packets through the respective selected communication paths. Hence, even when the line speed of a path other than the high-latency communication path has become further higher, the frequency of Head Of Line blocking is lowered, whereby resolution waiting time for the packet arrival sequence to the reception device can be reduced. Hence, a transfer delay of packets occurring downstream from the reception device can be suppressed.

The device and the processing thereof described in the present disclosure may be implemented by a dedicated computer which is provided by configuring a processor that is programmed to execute one or more functions embodied by a computer program. Alternatively, the device and the processing thereof described in the present disclosure may be implemented by a dedicated computer which is provided by configuring a processor with a dedicated hardware logic circuit. Alternatively, the device and the processing thereof described in the present disclosure may be implemented by one or more dedicated computers which are configured by combining a processor that executes a computer program, with one or more hardware logic circuits. Furthermore, the computer program may be stored in a computer readable non-transitory tangible storage medium, as instructions to be executed by the computer.

The present disclosure has so far been described based on embodiments. However, the present disclosure should not be construed as being limited to these embodiments or the structures. The present disclosure should encompass various modifications, and modifications within the range of equivalence. In addition, various combinations and modes, as well as other combinations and modes, including those which include one or more additional elements, or those which include fewer elements should be construed as being within the scope and spirit of the present disclosure.

The following are additional aspects.

### (Additional Matter 1)

A transmission device (10) that transmits a plurality of packets through a plurality of communication paths with load distribution, the device including:
a calculation unit (12) that, based on data amounts of packets held in a holding unit, which holds the plurality of packets arriving from a higher layer in order of arrival, and line speeds of the plurality of communication paths, calculates predicted delays, which are time periods required for arrival of the packets at a reception device when the packets are transmitted through the plurality of communication paths;
a selection unit (14) that, when selecting the communication paths that transmit the plurality of packets so that the plurality of packets are received by the reception device in the order of arrival, as a packet to be transmitted through a high-latency communication path having the largest predicted delay when packets having the same data amount are transmitted, selects a packet that is later in the order of arrival than another packet that is selected based on the predicted delay; and
a transmission unit (16) that transmits the plurality of packets through the respective communication paths selected by the selection unit.

### (Additional Matter 2)

The transmission device according to additional matter 1, wherein
the selection unit uses sequence numbers that are applied to the packets held in the holding unit in the order of arrival to select, as the packet that is later in the order of arrival, a packet having a sequence number that is obtained by providing a margin to the sequence number of the packet selected based on the predicted delay.

### (Additional Matter 3)

The transmission device according to additional matter 2, wherein
the selection unit sets the margin based on the predicted delay regarding packets that are capable of being transmitted within an allowable delay that is a value set to balance load distribution between the plurality of communication paths.

### (Additional Matter 4)

The transmission device according to additional matter 2, wherein
the selection unit sets the margin corresponding to a predicted delay difference that is a difference between a predicted delay of a packet to be transmitted through the high-latency communication path and a predicted delay of a packet to be transmitted through a low-latency communication path.
   (Additional matter 5)

The transmission device according to additional matter 2, wherein
the selection unit sets the margin corresponding to a line speed of a low-latency communication path among the plurality of communication paths.

### (Additional Matter 6)

The transmission device according to additional matter 4, wherein
the selection unit sets the margin corresponding to an offset obtained by multiplying the predicted delay difference by a line speed of the low-latency communication path.

### (Additional Matter 7)

The transmission device according to any one of additional matters 2 to 6, wherein
the selection unit defines the margin by a natural number.

### (Additional Matter 8)

The transmission device according to any one of additional matters 2 to 6, wherein
if data amounts of the plurality of packets are not the same, the selection unit defines the margin by the data amount and selects, as the packet that is later in the order of arrival, a predetermined packet in a case in which a difference between the sum of the data amounts of sequential packets, which is from the packet next to the packet selected based on the predicted delay to the predetermined packet and the data amount defined as the margin is within a predetermined range.

### (Additional Matter 9)

The transmission device according to any one of additional matters 2 to 8, wherein
if two or more low-latency communication paths are present, the selection unit sets the sum of margins regarding the low-latency communication paths as a final margin.

### (Additional Matter 10)

The transmission device according to any one of additional matters 1 to 9, wherein
the transmission unit transmits the packets, the number of which is completely transmitted within an allowable delay set to balance load distribution between the plurality of communication paths.

An aspect of the present disclosure is a transmission device that transmits a plurality of packets through a plurality of communication paths with load distribution, the device including: a calculation unit that, based on data amounts of packets held in a holding unit, which holds the plurality of packets arriving from a higher layer in order of arrival, and line speeds of the plurality of communication paths, calculates predicted delays, which are time periods required for arrival of the packets at a reception device when the packets are transmitted through the plurality of communication paths; a selection unit that, when selecting the communication paths that transmit the plurality of packets so that the plurality of packets are received by the reception device in the order of arrival, as a packet to be transmitted through a high-latency communication path having the largest predicted delay when packets having the same data amount are transmitted, selects a packet that is later in the order of arrival than another packet that is selected based on the predicted delay; and a transmission unit that transmits the plurality of packets through the respective communication paths selected by the selection unit.

Another aspect of the present disclosure is a transmission method that performs a process by a computer to transmit a plurality of packets through a plurality of communication paths with load distribution, the method including: based on data amounts of packets held in a holding unit, which holds the plurality of packets arriving from a higher layer in order of arrival, and line speeds of the plurality of communication paths, calculating predicted delays, which are time periods required for arrival of the packets at a reception device when the packets are transmitted through the plurality of communication paths; when selecting the communication paths that transmit the plurality of packets so that the plurality of packets are received by the reception device in the order of arrival, as a packet to be transmitted through a high-latency communication path having the largest predicted delay when packets having the same data amount are transmitted, selecting a packet that is later in the order of arrival than another packet that is selected based on the predicted delay; and transmitting the plurality of packets through the respective communication paths selected by the selection unit.

Another aspect of the present disclosure is a storage medium in which a transmission program is stored to cause a computer, which configures a transmission device that transmits a plurality of packets through a plurality of communication paths with load distribution, to function as: a calculation unit that, based on data amounts of packets held in a holding unit, which holds the plurality of packets arriving from a higher layer in order of arrival, and line speeds of the plurality of communication paths, calculates predicted delays, which are time periods required for arrival of the packets at a reception device when the packets are transmitted through the plurality of communication paths; a selection unit that, when selecting the communication paths that transmit the plurality of packets so that the plurality of packets are received by the reception device in the order of arrival, as a packet to be transmitted through a high-latency communication path having the largest predicted delay when packets having the same data amount are transmitted, selects a packet that is later in the order of arrival than another packet that is selected based on the predicted delay; and a transmission unit that transmits the plurality of packets through the respective communication paths selected by the selection unit.

According to the transmission device, the transmission method, and the storage medium of the present disclosure, a transfer delay on the reception side can be suppressed even when a path in which a delay is short speeds up more than expected when packets are transmitted through a plurality of communication paths with load distribution.

What is claimed is:

1. A transmission device that transmits a plurality of packets through a plurality of communication paths with load distribution, the device comprising:
a calculation unit that, based on data amounts of packets held in a holding unit, which holds the plurality of packets arriving from a higher layer in order of arrival, and line speeds of the plurality of communication paths, calculates predicted delays, which are time periods required for arrival of the packets at a reception device when the packets are transmitted through the plurality of communication paths;
a selection unit that, when selecting the communication paths that transmit the plurality of packets so that the plurality of packets are received by the reception device in the order of arrival, as a packet to be transmitted through a high-latency communication path having the largest predicted delay when packets having the same data amount are transmitted, selects a packet that is later in the order of arrival than another packet that is selected based on the predicted delay; and
a transmission unit that transmits the plurality of packets through the respective communication paths selected by the selection unit.

2. The transmission device according to claim 1, wherein
the selection unit uses sequence numbers that are applied to the packets held in the holding unit in the order of arrival to select, as the packet that is later in the order of arrival, a packet having a sequence number that is obtained by providing a margin to the sequence number of the packet selected based on the predicted delay.

3. The transmission device according to claim 2, wherein
the selection unit sets the margin based on the predicted delay regarding packets that are capable of being transmitted within an allowable delay that is a value set to balance load distribution between the plurality of communication paths.

4. The transmission device according to claim 2, wherein
the selection unit sets the margin corresponding to a predicted delay difference that is a difference between a predicted delay of a packet to be transmitted through the high-latency communication path and a predicted delay of a packet to be transmitted through a low-latency communication path.

5. The transmission device according to claim 2, wherein
the selection unit sets the margin corresponding to a line speed of a low-latency communication path among the plurality of communication paths.

6. The transmission device according to claim 4, wherein
the selection unit sets the margin corresponding to an offset obtained by multiplying the predicted delay difference by a line speed of the low-latency communication path.

7. The transmission device according to claim 2, wherein the selection unit defines the margin by a natural number.

8. The transmission device according to claim 2, wherein
if data amounts of the plurality of packets are not the same, the selection unit defines the margin by the data amount and selects, as the packet that is later in the order of arrival, a predetermined packet in a case in which a difference between the sum of the data amounts of sequential packets, which is from the packet next to the packet selected based on the predicted delay to the predetermined packet and the data amount defined as the margin is within a predetermined range.

9. The transmission device according to claim 2, wherein
if two or more low-latency communication paths are present, the selection unit sets the sum of margins regarding the low-latency communication paths as a final margin.

10. The transmission device according to claim 1, wherein
the transmission unit transmits the packets, the number of which is completely transmitted within an allowable delay set to balance load distribution between the plurality of communication paths.

11. A transmission method that performs a process by a computer to transmit a plurality of packets through a plurality of communication paths with load distribution, the method comprising:
based on data amounts of packets held in a holding unit, which holds the plurality of packets arriving from a higher layer in order of arrival, and line speeds of the plurality of communication paths, calculating predicted delays, which are time periods required for arrival of the packets at a reception device when the packets are transmitted through the plurality of communication paths;
when selecting the communication paths that transmit the plurality of packets so that the plurality of packets are received by the reception device in the order of arrival, as a packet to be transmitted through a high-latency communication path having the largest predicted delay when packets having the same data amount are transmitted, selecting a packet that is later in the order of arrival than another packet that is selected based on the predicted delay; and
transmitting the plurality of packets through the respective communication paths selected by the selection unit.

12. A storage medium in which a transmission program is stored to cause a computer, which configures a transmission device that transmits a plurality of packets through a plurality of communication paths with load distribution, to function as:
a calculation unit that, based on data amounts of packets held in a holding unit, which holds the plurality of packets arriving from a higher layer in order of arrival, and line speeds of the plurality of communication paths, calculates predicted delays, which are time periods required for arrival of the packets at a reception device when the packets are transmitted through the plurality of communication paths;
a selection unit that, when selecting the communication paths that transmit the plurality of packets so that the plurality of packets are received by the reception device in the order of arrival, as a packet to be transmitted through a high-latency communication path having the largest predicted delay when packets having the same data amount are transmitted, selects a packet that is later in the order of arrival than another packet that is selected based on the predicted delay; and
a transmission unit that transmits the plurality of packets through the respective communication paths selected by the selection unit.
